(19) United States
(12) Patent Application Publication
(10) Pub. No.: US 2011/0208595 A1
(43) Pub. Date: Aug. 25, 2011

(54) METHOD AND SYSTEM FOR MANAGING AND TRACKING ELECTRONIC ADVERTISING

(75) Inventors: Seth Besmertnik, New York, NY (US); Jeremy Duboys, Margate, NJ (US)

(73) Assignee: CONDUCTOR, INC., New York, NY (US)

(21) Appl. No.: 13/032,111

(22) Filed: Feb. 22, 2011

Related U.S. Application Data
(62) Division of application No. 11/349,452, filed on Feb. 7, 2006, now abandoned.
(60) Provisional application No. 60/650,743, filed on Feb. 7, 2005.

(51) Int. Cl. G06Q 30/00

(52) U.S. Cl. 705/14.69; 705/14.73

(57) ABSTRACT

A method and system for managing electronic advertising, indexable link templates are provided that are purchased by advertisers. The indexable link templates allow electronic advertising information to be input along with description information used for indexing by electronic search engines. The indexable link templates are filled with information by the advertiser and sent to one or more publisher's web-sites for display as static mark-up language text-link advertisements. The information allows search engine indexing, search engine placement and a higher search engine ranking that can potentially bring tens of thousands of users to an advertiser's web-site without having to spend additional money on click or impression advertising.

### CROSS REFERENCES TO RELATED APPLICATIONS

This application claims priority from U.S. Provisional Application 60/650,743, filed Feb. 7, 2005, the contents of which are incorporated by reference.

### FIELD OF THE INVENTION

This invention relates to electronic advertising. More specifically, it relates to a method and system for managing and implementing electronic advertising that is indexable by the search engines.

### BACKGROUND OF THE INVENTION

The Internet and World-Wide-Web have changed the way organizations conduct business. Virtually every organization has a web-site that provides information about the organization and a description of the goods and/or services an organization may offer. As is known in the art, a “web-site” is group of related mark-up language documents and associated graphics and multi-media files, scripts, and databases, etc. that are served up by a server on the World-Wide-Web via the Internet. Business organizations also provide an electronic commerce (e-commerce) interface that allows users to purchase goods and/or services from such organizations.

There are many different types of web-sites on a spectrum ranging from very simple to very complex. Designing, implementing and deploying a web-site requires knowledge of markup languages such as Hyper Text Markup Language (HTML), eXtensible Markup Language (XML), programming languages such as JAVA, C++, C#, PHP Perl, Cold Fusion, ASP, computer graphics functionality, multi-media functionality, etc. A knowledge of communications protocols such as Hyper Text Transfer Protocol (HTTP), Transmission Control Protocol (TCP), Internet Protocol (IP), e-mail protocols such as Simple Mail Transfer Protocol (SMTP), e-commerce protocols, encryption and other security protocols and many other types of protocols for various kinds of web functionalities.

Commercial web-sites offer many different types of electronic advertisements. The advertisements typically include electronic links to advertiser's web-sites. There are many problems associated with designing, implementing and deploying advertising on a web-site. Traditionally on automated advertising servers there is use of many different types of multimedia (e.g, flash media, javascript, visual basic script, etc.) or redirects that create an intermediary between a web-site and advertiser's web-site. This makes it impossible for search engines to index such multimedia advertising

Another problem is that many types of online advertising is considered spam. Another problem is that pop-up advertising is being block by operating systems such as Windows XP and add-on software. This pop-up blocking is becoming a standard feature in many operating systems. Another problem is that banner ads and pay-per-click ads are no longer an effective means of advertising online.

Another problem is that most electronic advertising does not include description information useable by electronic search engines. This makes it difficult for search engines to follow and/or index electronic advertising. Thus most electronic advertising misses out on additional opportunities that would be possible if the electronic advertising could be indexed by search engines.

Thus, it is desirable to provide advertising that can be tracked for advertiser's and indexed by search engines.

### SUMMARY OF THE INVENTION

In accordance with preferred embodiments of the present invention, some of the problems associated with tracking and implementing electronic advertising are overcome. A method and system for managing electronic advertising indexable by the search engines is presented.

indexable link templates are provided that are purchased by advertisers. The indexable link templates allow electronic advertising information to be input along with description information used for indexing by electronic search engines. The indexable link templates are filled with information by the advertiser and sent to one or more publisher's web-sites for display as static mark-up language text-link advertisements. The description information allows improved search engine placement and/or a higher search engine ranking that can potentially bring tens of thousands of users to an advertiser's web-site without having to spend additional money on click or impression advertising.

The foregoing and other features and advantages of preferred embodiments of the present invention will be more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating an exemplary electronic advertising system;

FIG. 2 is a flow diagram illustrating a method for managing electronic advertising;

FIG. 3 is a block diagram illustrating a screen dump of an automated graphical user interface used to accept electronic advertising information in an indexable link template;

FIG. 4 is a flow diagram illustrating a method for managing electronic advertising;

FIG. 5 is a flow diagram illustrating a method for tracking electronic advertising;

FIG. 6 is a block diagram illustrating a screen dump of an automated graphical user interface used to purchase advertising a publisher's web-sites;

FIG. 7 is a block diagram illustrating another screen dump of automated graphical user interface used to accept electronic advertising information in an indexable link template.

### DETAILED DESCRIPTION OF THE INVENTION

Exemplary Electronic Advertising System

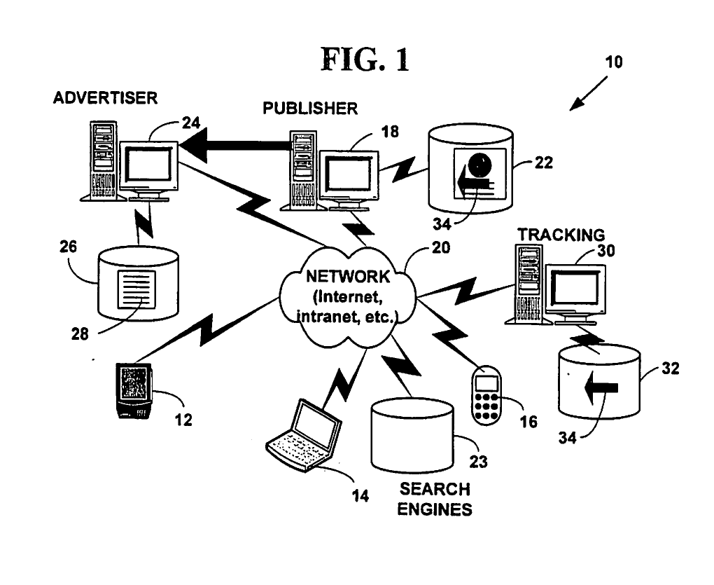

FIG. 1 is a block diagram illustrating an exemplary electronic advertising system 10. The electronic advertising system 10 includes, but is not limited to, plural network devices 12, 14, 16 (three of which are illustrated). The plural network devices 12, 14, 16 include but are not limited to desktop computers, laptop computers, personal digital/data assistants (PDAs), mobile phones, non-mobile phones, interactive TV systems through set top boxes for cable television (CATV), satellite television or other television networks, Internet appliances and other types of network devices.

The plural network devices 12, 14, 16 communicate with a one or more information servers 18 (one of which is illustrated) using one or more wired or wireless communications protocols over a communications network 20. The one or more information servers 18 include one or more servers hosting a web-site that publish electronic advertising information, hereinafter “publisher's web-site,” advertiser's web-sites, electronic search engines and other types of information servers. The one or more information servers 18 may also include file servers or other types of servers.

The communications network 20 includes, but is not limited to, the Internet, an intranet, a wired Local Area Network (LAN), a wireless LAN (WiLAN), a Wide Area Network (WAN), a Metropolitan Area Network (MAN), Public Switched Telephone Network (PSTN) and other types of communications networks 18 providing voice, video and data communications.

The communications network 20 may include one or more gateways, routers, or bridges. As is known in the art, a gateway connects computer networks using different network protocols and/or operating at different transmission capacities. A router receives transmitted messages and forwards them to their correct destinations over the most efficient available route. A bridge is a device that connects networks using the same communications protocols so that information can be passed from one network device to another.

The communications network 20 may also include one or more additional servers or access points (AP) including wired and wireless access points (WAP) (not illustrated). The one or more servers include web-site servers, file servers and other types of servers.

The one or more information servers 18 include one or more associated databases 22 (one of which is illustrated) that include electronic content including web-site content. The exemplary electronic advertising system 10 further includes one or more electronic search engines 23, one or more advertising servers 24 with one or more associated databases 26 (one of which is illustrated). The one or more associated databases 26 include plural electronic advertising information 28 in plural digital formats, including, but not limited to, Hyper Text Markup Language (HTML), Extensible Markup Language (XML), flash media, Java, Java Script, Visual Basic Script and various combinations thereof. The exemplary electronic advertising system 10 further includes one or more tracking servers 30 with one or more associated databases 32 (one of which is illustrated). The one or more tracking servers 30 are used to track electronic advertising information 28 and provide indexable link templates 34 as is described below.

Preferred embodiments of the present invention include network devices that are compliant with all or part of standards proposed by the Institute of Electrical and Electronic Engineers (“IEEE”), International Telecommunications Union-Telecommunication Standardization Sector (“ITU”), European Telecommunications Standards Institute (ETSI), Internet Engineering Task Force (“IETF”), U.S. National Institute of Security Technology (“NIST”), American National Standard Institute (“ANSI”), Wireless Application Protocol (“WAP”) Forum, Data Over Cable Service Interface Specification (DOCSIS), Bluetooth Forum, or the ADSL Forum. However, network devices based on other standards could also be used. IEEE standards can be found on the World Wide Web at the Universal Resource Locator (“URL”) “www.ieee.org.” The ITU, (formerly known as the CCITT) standards can be found at the URL “www.itu.ch.” ETSI standards can be found at the URL “www.etsi.org.” IETF standards can be found at the URL “www.ietforg.” The NIST standards can be found at the URL “www.nist.gov.” The ANSI standards can be found at the URL “www.ansi.org.” DOCSIS documents can be found at the URL “www.cablemodem.com.” Bluetooth Forum documents can be found at the URL “www.bluetooth.com.” WAP Forum documents can be found at the URL “www.wapforum.org.” ADSL Forum documents can be found at the URL “www.adsl.com.”

The plural network devices 12, 14, 16 include a protocol stack with multiple layers based on the Internet Protocol or Opens Systems Interconnection (OSI) reference model. The protocol stack includes, but is not limited to, Transmission Control Protocol (TCP), User Datagram Protocol (UDP), Internet Protocol (IP), Hypertext Transfer Protocol (HTTP) and other communication protocols and Rich Site Summary (RSS), ATOM and weblogs protocols.

As is known in the art, the OSI reference model is a layered architecture that standardizes levels of service and types of interaction for computers exchanging information through a communications network. The OSI reference model separates network device-to-network device communications into seven protocol layers, or levels, each building—and relying—upon the standards contained in the levels below it. The OSI reference model includes from lowest-to-highest, a physical, data-link, network, transport, session, presentation and application layer. The lowest of the seven layers deals solely with hardware links; the highest deals with software interactions at the application-program level.

TCP provides a connection-oriented, end-to-end reliable protocol designed to fit into a layered hierarchy of protocols that support multi-network applications. For more information on TCP 58 see RFC-793, incorporated herein by reference.

UDP provides a connectionless mode of communications with datagrams in an interconnected set of networks. For more information on UDP see ITEF RFC-768 incorporated herein by reference.

IP is an addressing protocol designed to route traffic within a network or between networks. For more information on IP 54 see IETF RFC-791 incorporated herein by reference.

HTTP is a standard protocol for communications on the World Wide Web. For more information on HTTP, see IETF RFC-2616 incorporated herein by reference.

Really Simple Syndication or Rich Site Summary (RSS) is a family content distribution and republication (i.e., syndication) protocols primarily used by news sites and weblogs.

The Rich Site Summary (RSS) is also know as RSS 0.91, 0.92 and RSS 2.x. The Resource Description Framework (RDF) Site Summary (also RSS) is based on Netscape's RSS 0.90, which uses the World Wide Web Consortium (W3C) Resource Description Framework Standard known as RSS 1.x.

RSS provides a lightweight eXtensible Markup Language (XML) format designed for sharing electronic information such as news headlines and other electronic content on the World-Wide-Web. RSS was first developed by Netscape to drive channels for the Netscape Netcenter.

“ATOM” is an XML-based file format intended to allow lists of related information, known as “feeds,” to be synchronized between publishers and consumers. Feeds are composed of a number of items, known as “entries”, each with an extensible set of attached metadata. For example, each entry has a title. More information about ATOM is available on the Internet at the URL “atomenabled.org.”

Sharing information content for distribution in many different channels on the World-Wide-Web is called “syndication.” Web syndication is a form of syndication in which a section of a web-site is made available for other sites to use. For example, news information, weblogs, etc. may be syndicated. As is known in the art, a “weblog” is a web application that contains periodic ordered postings of information on a common web-page. Webblogs include individual diaries, political, consumer, commercial and other types of information.

An operating environment for the devices used in the digital publishing system 10 include a processing system with one or more high speed Central Processing Unit(s) (“CPU”), one or more processors and one or more memories. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU-executed,” or “processor-executed.”

It will be appreciated that acts and symbolically represented operations or instructions include the manipulation of electrical signals or biological signals by the CPU or processor. An electrical system or biological system represents data bits which cause a resulting transformation or reduction of the electrical signals or biological signals, and the maintenance of data bits at memory locations in a memory system to thereby reconfigure or otherwise alter the CPU's or processor's operation, as well as other processing of signals. The memory locations where data bits are maintained are physical locations that have particular electrical, magnetic, optical, or organic properties corresponding to the data bits.

The data bits may also be maintained on a computer readable medium including magnetic disks, optical disks, organic memory, and any other volatile (e.g., Random Access Memory (“RAM”)) or non-volatile (e.g., Read-Only Memory (“ROM”), flash memory, etc.) mass storage system readable by the CPU. The computer readable medium includes cooperating or interconnected computer readable medium, which exist exclusively on the processing system or can be distributed among multiple interconnected processing systems that may be local or remote to the processing system.

### Exemplary Electronic Advertising Management Method

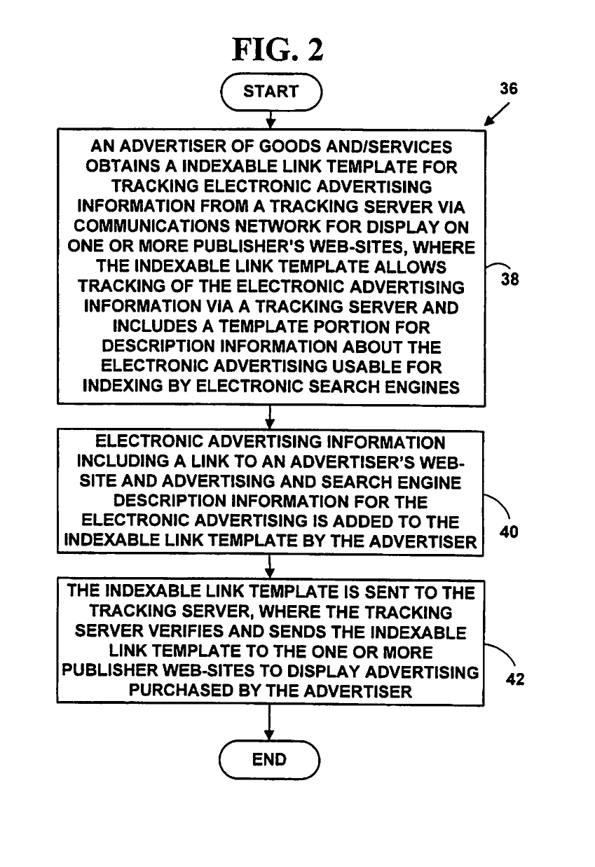

FIG. 2 is a flow diagram illustrating a Method 36 for managing electronic advertising. At Step 38, an indexable link template for tracking electronic advertising information is obtained by an advertiser of goods and/or services from a tracking server via communications network for display on one or more publisher's web-sites. The indexable link template allows tracking of the electronic advertising information via a tracking server and includes a search engine template portion for description information about the electronic advertising usable for indexing by electronic search engines. At Step 40, electronic advertising information including one or more links to an advertiser's web-site and advertising and search engine description information is added to the indexable link template by the advertiser. At Step 42, the indexable link template is sent to the tracking server. The tracking server verifies and the indexable link template and sends it to the one or more publisher web-sites to display advertising purchased by the advertiser.

The indexable link template provides advertising on the one more publisher's web-sites including a link to the advertiser's web-site and allows tracking of electronic advertising information by the tracking server and allows indexing of the advertising information by electronic search engines such as Google, Lycos, MSN and'other public and private search engines available for use on the Internet. The search engine template portion of the indexable link template also allows the advertiser to increase a search engine ranking of the advertiser's web-site on one or more search engines when the advertising in the indexable link template is accessed on the one or more publisher web-sites. The search engine template portion also allows input of keywords. Publisher's can be tracked and searched for by keywords stored in the indexable link template 34.

Method 36 is illustrated with an exemplary embodiment. However, the invention is not limited to this exemplary embodiment and other embodiment can also be used to practice the invention.

In such an exemplary embodiment At Step 38, an indexable link template 34 for tracking electronic advertising information 28 is purchased by an advertiser 24 from a tracking server 30 via an automated system accessible the Internet 20 or other communications network. The indexable link template 34 is published on one or more publisher's web-sites 18 to display advertising for the advertiser 24. In one embodiment, the advertiser 24 is a provider of goods and/or services. In another embodiment, the advertiser 24 is not a provider of any goods or services but advertises for providers of goods and/or services. The indexable link template 34 allows tracking of the electronic advertising information via a tracking server 30 and includes a template portion for description information about the electronic advertising usable for indexing by one or more electronic search engines 23.

The indexable link template 34 is purchased to be added to publisher's web-sites 18 that are visited by potential purchaser's of the advertiser's goods or services. For example, an advertiser for wedding and anniversary planning services may purchase a indexable link template 34 to be placed on one or more publisher's web-sites 18 including jewelry web-sites featuring information on high-end jewelry and engagement rings.

In one embodiment, the tracker server 30 has pre-negotiated and associations with one or more publisher's web-sites 18 to allow favorable placement of adds in the indexable link template 34.

In one embodiment, the purchase price includes a desired add placement on a publisher's web-site 18. For example, six advertisements may be displayed on the publisher's web-site 18 and the advertiser 24 may purchase the fourth position for display of his/her add. However, the present invention is not limited to this embodiment, and other factors may be used to determine a purchase price.

Table 1 illustrates other factors that are considered to determine a purchase price for a desired advertisement. However, the present invention is not limited to these factors and other factors may also be used to determine a purchase price.

TABLE 1

The intensity of traffic on the site.
The number of internal links on the site.
The number of pages on the site.
Where link ads are placed on the site.
How many backlinks are pointing to the site.
The credibility of the site within its demographic (target audience).
Scarcity of similar category sites.
Web-site, advertising and other ranking.

In one embodiment, the indexable link template 34 is a static mark-up language template (e.g., a static HTML or XML template, etc.) provided as a mark-up language form via the Internet 20. In another embodiment, the indexable link template 24 is e-mailed to the advertiser.

In one embodiment, the indexable link template 24 allows only text advertising content to be provided and is called a “text-link ad.” In another embodiment, the indexable link template 24 also other than text-link advertising content to be provided as is explained below. However, the present invention is not limited to these embodiment and other embodiments can be used to practice the invention.

Such text-link ads are quickly becoming one of the most cost-effective forms of online advertising available today on the Internet 20. Internet 20 users tired of being harassed by annoying ad formats are responding to this less obtrusive, more focused format of Internet 29 marketing. A huge benefit of using text-links ads is vastly improved search engine rankings and thus potentially a large number of additional clicks.

Traditionally, paying for one click or 1000 impressions, was the accepted practice for electronic advertising on the Internet. However, text links ads provide significant additional benefits through improved search engine placement that comes from the resulting adjacency to the electronic advertisement. The improved search engine placement and a higher search engine ranking can bring tens of thousands of users to an advertiser's web-site 18 every day without having to spend additional money on click or impression advertising. In one embodiment, advertisers can buy advertisements using the indexable link template 34 on a monthly basis which helps eliminate fraud.

The search engine template portion of the indexable link template 34 also allows the advertiser to increase a search engine ranking of the advertiser's web-site 24 on one or more electronic search engines 23 when the advertising in the indexable link template is accessed on the one or more publisher web-sites 18.

The concept of how links and search engines relate to one another, is one of the great mysteries of online commerce. Thousands of website owners have tried to figure out how search engines work out their rankings, and countless numbers have spent untold hours trying to work out ways to achieve better rankings.

Most search engines use a complex formula to calculate a placement on searches. These formulas, included, but are not limited to “backlinks” (i.e., a number of other web-sites that link to a web-site), internal links (i.e., web pages of linked to from within a web-site), keywords (i.e., words on a web-site which should indicate what the site is about), and popularity (i.e., a number of people who visit a web-site each week) and other factors.

The indexable link templates 34 are also used to increase a number of electronic links to a web-site. In the old days, webmasters would contact hundreds of other webmasters and ask (or even beg) for another electronic link, generally offering a mutual swap in return. But that time-consuming job quickly became a difficult when other web-sites didn't hold up their end of the bargain, or when a large chunk of the traffic a web-site worked so hard to build disappeared to another web-site through those links. Also, reciprocal links are less valuable than one way incoming links. The indexable link template 34 increases a search engine rank on the one or more electronic search engines 23 by creating additional one-way (and two-way) electronic links from the one or more publisher web-sites 18 to the advertiser's web-site 24.

Advertiser use the indexable link templates 34 to place search engine friendly text-link advertisements, graphical advertisements, webblog advertisements, RSS, advertisements, ATOM advertisements, rotating advertisements (i.e., two or more advertisements that rotate periodically, etc.), and other types of multi-media and non-multimedia advertisements. Publisher's can also benefit from using search friendly text-link advertisements via purchase of indexable link templates 34. Publisher's can also sell or re-sell advertising using indexable link templates 34.

At Step 40, electronic advertising information including electronic advertising content 28, one or more electronic links to the advertiser's web-site 24 and description information for electronic search engines is added to the indexable link template 34 by the advertiser.

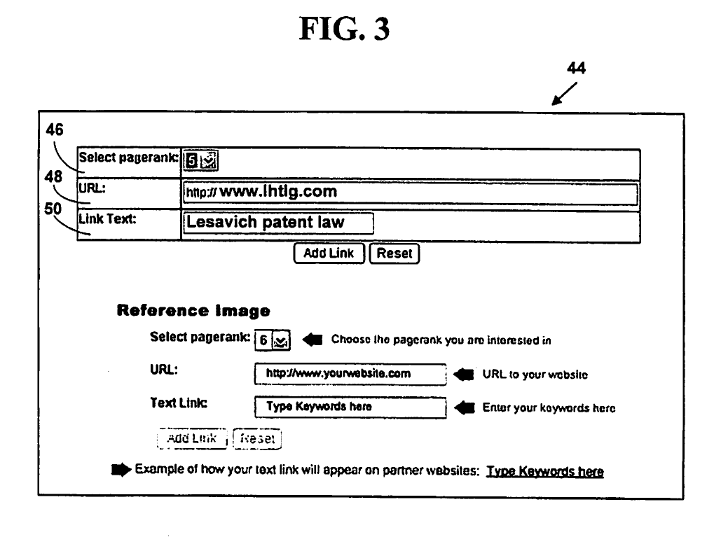

FIG. 3 is a block diagram illustrating a screen dump 44 of an automated graphical user interface used to accept electronic advertising information 28 in the indexable link template 34 from an advertiser 18 as displayed by the tracking server 30.

In one embodiment, the description information includes a desired advertising page ranking 46 on an electronic search engine, a URL 50 including a link to the advertiser's web-site 24, one or more advertising key words and/or a textual description 52 about the electronic advertising content 28 and one or more additional links or pieces of information added to the URL to allow indexing and tracking of the electronic advertising information 28 in the indexable link template 34. However, the indexable link template 34 of present invention is not limited to this embodiment and more or fewer types of information can be added to the indexable link template 34 and other indexable link template 34 embodiments can be used to practice the invention.

Returning to FIG. 2 at Step 42, the indexable link template 34 is sent to the tracking server 30 and the tracking server 30 sends the indexable link template 34 to one or more publisher web-sites 18 purchased by the advertiser 24. The indexable link template 34 provides advertising on the one or more publisher's web-sites 18 including a link to the advertiser's web-site 24 and allows tracking of electronic advertising information 28 by the tracking server 30 and allows indexing of the advertising information by one or more electronic search engines 23.

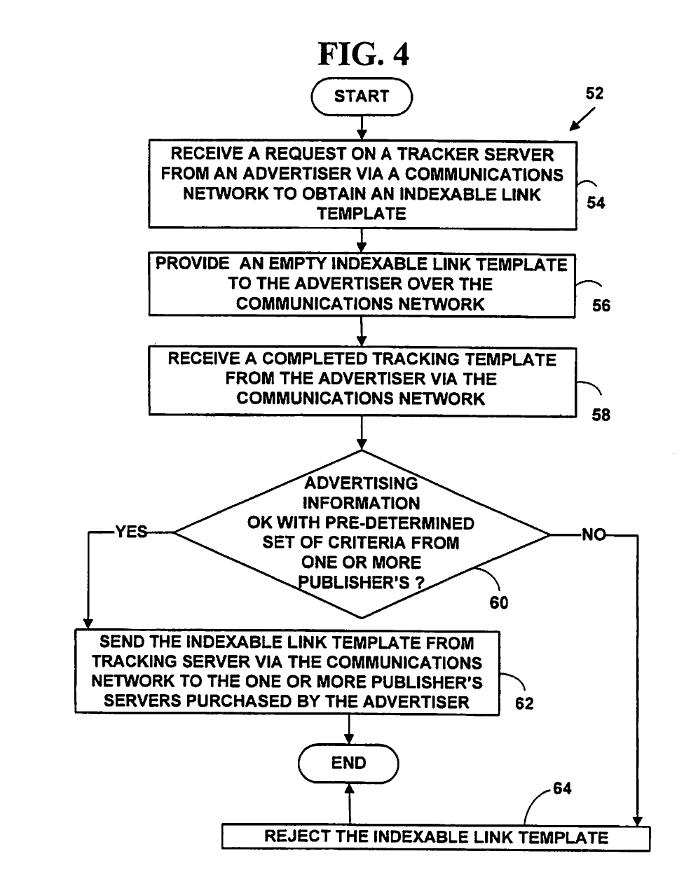

FIG. 4 is a flow diagram illustrating a Method 52 for managing electronic advertising. At Step 54, a request is received on a tracking server from an advertiser via a communications network to purchase an indexable link template. The indexable link template allows tracking of the electronic advertising information via the tracking server and includes a template portion for description information about the electronic advertising usable for electronic search engines. At Step 56, an empty indexable link template is provided to the advertiser over the communications network. At Step 58, a completed indexable link template is received from the advertiser via the communications network. At Step 60, a test is conducted to determine if the electronic advertising information in the indexable link template meets a pre-determined set of criteria provided by the one or more publisher's. If the electronic advertising information meets the pre-determined set of criteria provided by the one or more publisher's, at Step 62, the indexable link template is provided by the tracking server via the communications network to the one or more publisher's servers purchased by the advertiser. If the electronic advertising information does not meet the pre-determined set of criteria provided by the one or more publisher's, the indexable link template is rejected by the tracking server at Step 64.

Method 54 is illustrated with an exemplary embodiment. However, the invention is not limited to this exemplary embodiment and other embodiments can also be used to practice the invention.

In such an exemplary embodiment, at Step 56, a request is received on a tracking server 30 from an advertiser 24 via the Internet 20 to purchase an indexable link template 34. The indexable link template 34 allows tracking of the electronic advertising information via the tracking server 30 and includes a template portion for description information about the electronic advertising usable for electronic search engines as was described above. At Step 56, an empty indexable link template 34 (e.g., FIG. 3) is provided to the advertiser 24 over the Internet 20 from the tracking server 30.

At Step 58, a completed tracking template 34 is received from the advertiser. The completed tracking template 34 includes electronic advertising information 28 and description information about the electronic advertising information 28 usable for electronic search engines.

At Step 60, a test is conducted to determine if the electronic advertising information 28 in the indexable link template 34 meets a pre-determined set of criteria provided by the one or more publisher's web-sites 18. For example publisher-X's web-site may provide advertising guidelines that prohibit any type of pornography. If an advertiser that purchased a indexable link template 34 added advertising information related to pornography, the indexable link template 34 would be rejected. In one embodiment, the approval process is automated. In another embodiment, the approval process is manual and completed by human support technicians employed by the tracking web-site 30.

If the electronic advertising information 28 does not meet the pre-determined set of criteria provided by the one or more publisher's, the indexable link template 34 is rejected by the tracker server 30 at Step 62. The advertiser 24 would than have a chance to change the electronic advertising information 28 to meet the pre-determined criteria of the one or more publisher's 18 and/or receive a purchase refund.

If the electronic advertising information 28 meets the pre-determined set of criteria provided by the one or more publisher's web-sites 18 at Step 62, the indexable link template 34 is provided by the tracking server 30 to the one or more publisher's servers 18 purchased by the advertiser 24. The publisher's web-sites 18 publish the indexable link template 34 to make the electronic advertising available 28 as well as make the description information for the advertisement available for indexing by electronic search engines.

### Exemplary Advertising Tracking Method

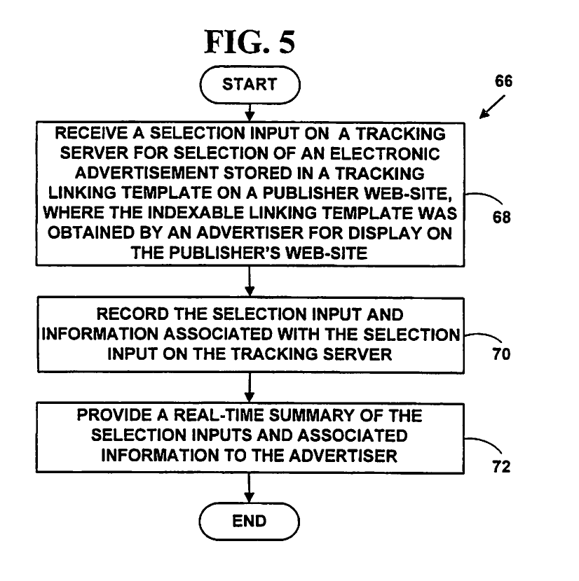

FIG. 5 is a flow diagram illustrating a Method 66 for tracking electronic advertising. At Step 68, a selection input is received on a tracking server for selection of electronic advertising stored in an indexable link template. In one embodiment, the indexable link template 34 was purchased by an advertiser. At Step 70, information associated with the selection input is stored in a database associated with the tracking server. At Step 72, summary information about recorded selection input is sent in real-time to the advertiser.

Method 66 is illustrated with an exemplary embodiment. However, the invention is not limited to this exemplary embodiment and other embodiments can also be used to practice the invention.

In such an exemplary embodiment, at Step 68, a selection input event or message (e.g., a mouse click, etc.) is received on a tracking server 30 for selection of electronic advertising 28 stored in an indexable link template 34. The indexable link template 34 was purchased by an advertiser 24 for display on one or more publisher's web-sites 18.

At Step 70, information associated with the selection input is stored in a database 32 associated with the tracking server 30. Information associated with the selection input includes, but is not limited to, IP address of the publisher web-site, electronic advertising information 28 identifier, indexable link template identifier 34, an IP address of a viewer who generated the selection input, etc.

At Step 72, summary information about recorded selection input is sent to the advertiser 18 from the tracking server 30 in real-time. The summary information includes, but is not limited to, number of times the electronic advertising information 28 in the indexable link template 34 was selected from the publisher's web-sites 24 and the electronic search engines 23, how many impressions were selected, search engine 23 rank or other summary information recorded at Step 70. Step 72 allows advertisers to obtain advertising summary information in real-time.

The methods and system described herein allow advertiser's purchase and place friendly text-link advertisements using an automated graphical user interface (GUI) and system via the Internet.

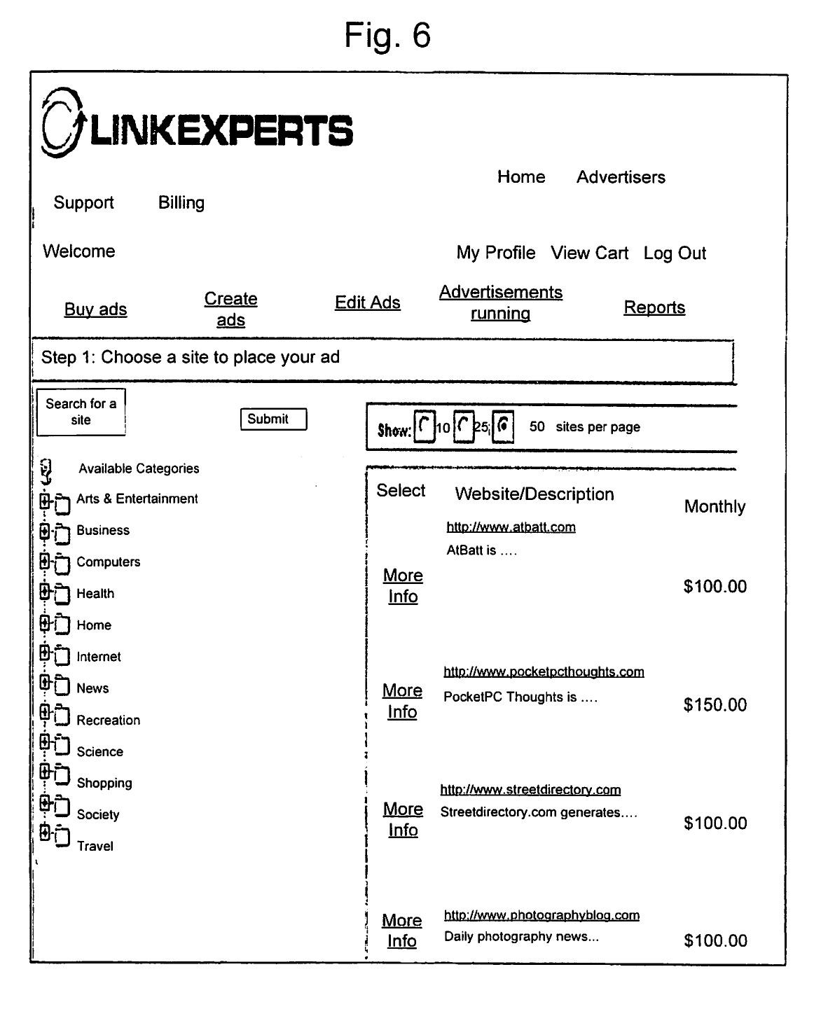

FIG. 6 is a block diagram illustrating a screen dump 74 of an automated graphical user interface used to purchase advertising a publisher's web-sites;

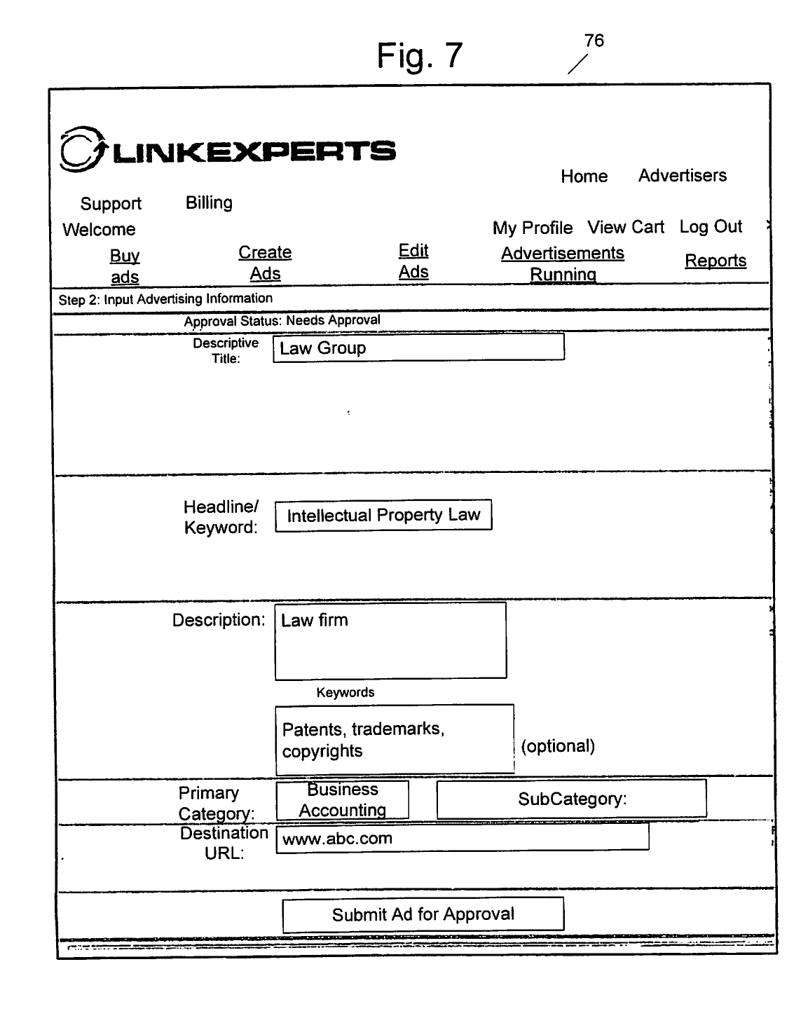

FIG. 7 is a block diagram illustrating another screen dump 76 of automated graphical user interface used to accept electronic advertising information in an indexable link template.

The methods and system described herein provide at least the ability to: (1) track impressions of advertisements stored in indexable link templates; (2) track click-throughs for each advertisement stored in indexable link templates; (3) increase search engine indexing and rankings via search engine template portion of the indexable link templates and increase search engine indexing via creation of addition one-way or two-way electronic links from one or publisher's web-sites to an advertiser's web-site; (4) for the advertiser to move his/her ad instantly to another page on the same website without disrupting his/her advertising; (5) for the advertiser to change the advertisements and URL in the tracking link template on the fly; (6) for the advertiser to purchase and cancel links instantly with no human involvement besides the approval of the link, when the link is originally purchased; and (7) After the initial set up—publishing web-sites sites have no needed further involvement to make the indexable link template functional.

It should be understood that the architecture, programs, processes, methods and It should be understood that the architecture, programs, processes, methods and systems described herein are not related or limited to any particular type of computer or network system (hardware or software), unless indicated otherwise. Various types of general purpose or specialized computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented in software, in other embodiments hardware or firmware implementations may alternatively be used, and vice-versa.

The claims should not be read as limited to the described order or elements unless stated to that effect. In addition, use of the term “means” in any claim is intended to invoke 35 U.S.C. §112, paragraph 6, and any claim without the word “means” is not so intended.

Therefore, all embodiments that come within the scope and spirit of the following claims and equivalents thereto are claimed as the invention.

What is claimed is:

1. A method for managing electronic advertising, comprising:
obtaining on a target network device with one or more processors an indexable link template for tracking electronic advertising information by an advertiser of goods or services from a tracking server network device with one or more processors via communications network for display on one or more publisher's web-sites on one or more server network devices each with one or more processors, wherein the indexable link template includes an electronic advertising information portion for adding electronic advertising information and a search engine template portion for description information about the electronic advertising usable for indexing by one or more electronic search engines and for tracking the electronic advertising via the one or more electronic search engines:
adding from the target network device electronic advertising information including one or more electronic links to an advertiser's web-site on an advertising server network device with one or more processors and advertising and search engine description information to the indexable link template;
sending the indexable link template to the tracking server network device via the communications network, wherein the tracking server network device verifies content of the indexable link template;
automatically creating via the tracking server network device a plurality of additional one-way and two-way electronic links from the one or more publisher web-sites to the advertiser's web-site using the indexable link template, wherein the plurality of additional one-way and two-way links increase search engine rankings on the one or more search engines for the electronic advertising information for the advertiser;
sending the indexable link template to the one or more publisher web-sites available on one or more publisher server network devices to display advertising purchased by the advertiser; and
tracking in real-time the electronic advertising information for the advertiser via the tracking server network device via the indexable link template.

2. One or more processors on one or more network devices executing a plurality of instructions stored in a computer readable medium including the steps of the method of claim 1.

3. The method of claim 1 wherein the search engine template portion of the indexable link template allows keywords to be input and also allows the advertiser to increase a search engine ranking of the advertiser's web-site on one or more electronic search engines when the advertising in the indexable link template is accessed on the one or more publisher web-sites.

4. The method of claim 1 wherein the obtaining step includes purchasing the indexable link template by an advertiser from a tracking server network device via Internet to be published on one or more publisher's web-sites to display advertising for the advertiser.

5. The method of claim 1 wherein the indexable link template is a static mark-up language template.

6. The method of claim 1 wherein the adding step includes adding only text advertising content to the indexable link template.

7. The method of claim 1 wherein the electronic advertising information includes text-link advertising, graphical advertising, webblog advertising, Rich Site Summary (RSS) advertising, ATOM advertising, rotating advertising, or multi-media advertising information.

8. The method of claim 7 wherein the text-link advertising information includes one or more electronic links to electronic information on other web-sites.

9. The method of claim 7 wherein the text-link advertising provides improved search engine rankings.

10. A method for managing electronic advertising comprising:
receiving a request on a the tracking server network device with one or more processors from the advertiser network device with one or more processors via the communications network to obtain the indexable link template;
providing an empty indexable link template to the advertiser network device over the communications network;
receiving a completed indexable link template from the advertiser network device via the communications network, wherein the indexable link template includes an electronic advertising information portion adding electronic advertising information and a search engine template portion for description information about the electronic advertising usable for indexing by one or more electronic search engines; and
determining on the tracking server network device whether electronic advertising information in the completed indexable link template meets a pre-determined set of criteria provided by one or more publisher's, and
if so, automatically creating via the tracking server network device a plurality of additional one-way and two-way electronic links from one or more publisher web-sites to advertiser's web-site using the indexable link template, wherein the plurality of additional one-way and two-way links increase search engine rankings on the one or more search engines for the electronic advertising information for the advertiser, and
providing the completed indexable link template by the tracking server network device via the communications network to the one or more publisher's web-sites purchased by the advertiser, and
if not, rejecting the completed indexable link template on the tracking server network device.

11. One or more processors on one or more network devices executing a plurality of instructions stored in a computer readable medium including the steps of the method of claim 10.

12. The method of claim 10 wherein the indexable link template allows tracking of the electronic advertising information via the tracking server network device and includes a search engine template portion for description information about the electronic advertising usable for indexing by one or more electronic search engines.

13. The method of claim 10 wherein the providing step includes providing electronic purchasing of the indexable link template by the advertiser network device from a tracking server network device via Internet to be published on one or more publisher's web-sites to display advertising for the advertiser.

14. The method of claim 10 further comprising publishing the indexable link template on one or more publisher's server network devices making electronic advertising available and description information in the indexable link template for indexing by electronic search engines.

15. The method of claim 14 wherein the publishing step includes publishing the indexable link template on one or more publisher's server network devices purchased by the advertiser making electronic advertising and the description information in the indexable link template available for indexing by one or more electronic search engines thereby increasing a search engine ranking on the one or more electronic search engines and wherein the indexable link template also increases a search engine ranking on the one or more electronic search engines by creating additional electronic links from one or more web-sites on the one or more publisher's server network devices to an advertiser's web-site.

16. The method of claim 10 further comprising:
receiving a selection input on a the tracking server network device for selection of electronic advertising stored in the indexable link template;
storing information associated with the selection input in a database associated with the tracking server network device: and
sending in real-time summary information about the recorded selection input to the advertiser server network device from the tracking server network device.

17. The method of claim 16 wherein the step of storing information includes storing an Internet Protocol (IP) address of a publisher web-site from which the selection input was received, an electronic advertising information identifier, an indexable link template identifier, or an IP address of a viewer who generated the selection input.

18. The method of claim 16 wherein the sending step includes sending summary information including a number of times electronic advertising information in the indexable link template was selected at a publisher's web-site or an electronic search engine, a search engine ranking or the summary information stored in the database.

19. A system for managing electronic advertising, comprising in combination:
means for providing purchasable electronic advertising information for an advertiser from a tracking server device with one or more processors;
means for providing from a tracking server network device an empty indexable link template to an advertiser network server device with one or more processors over a communications network;
means for receiving on the tracking server network device a completed indexable link template from the advertiser server network device via the communications network, wherein the indexable link template includes an advertising portion and a search engine template portion for description information about the electronic advertising usable for indexing by one or more electronic search engines, wherein the indexable link template increases a search engine ranking on the one or more electronic search engines for an advertiser's web-site;
means for automatically creating via the tracking server network device a plurality of additional one-way and two-way electronic links from one the or more publisher web-sites to advertiser's web-site using the indexable link template, wherein the plurality of additional one-way and two-way links increase search engine rankings on the one or more search engines for the advertiser:
means for providing the completed indexable link template from the tracking server network device via the communications network to one or more publisher's servers each with one or more processors purchased by the advertiser, wherein the indexable link template increases a search engine ranking on the one or more electronic search engines by creating additional electronic links from one or more web-sites on the one or more publisher servers to an advertiser's web-site; and
means for tracking use of the indexable link template from the tracking server network device in real-time and providing summary information in real-time via the tracking server network device via the communications network.
